(19) United States
(12) Patent Application Publication
(10) Pub. No.: US 2008/0138096 A1
(43) Pub. Date: Jun. 12, 2008

(54) Detached apparatus identifying method and an image forming device including the same

(75) Inventors: Paul M. Wegman, Pittsford, NY (US); Paul K. Acquaviva, Fairport, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/635,431

(22) Filed: Dec. 7, 2006

(51) Int. Cl. G03G 15/00

(52) U.S. Cl. 399/12

(57) ABSTRACT

An image forming device is arranged to identify a detached apparatus and to provide one or more signals based on the detached apparatus. The one or more signals include at least a user signal based on when the detached apparatus can be attached to or used with the image forming device.

### CROSS-REFERENCE TO RELATED APPLICATIONS

This application is a member of a group of “sister” commonly-filed applications, the group comprising exactly four (4) co-filed application members, the first (1st) application member having Attorney Docket Number 20051423-US-NP, the second (2nd) application member having Attorney Docket Number 20051423Q-US-NP, the third (3rd) application member having Attorney Docket Number 20051423Q1-US-NP, and the fourth (4th) application member having Attorney Docket Number 20051423Q2-US-NP; the foregoing group of commonly-filed applications sharing the following four (4) common, same, equal and identical attributes: (i) Filing date; (ii) Inventorship, namely, Paul M. Wegman and Paul K. Acquaviva; (iii) Title, namely, “Detached apparatus identifying method and an image forming device including the same”; and (iv) Assignee, namely, Xerox Corporation.

### INCORPORATION BY REFERENCE OF OTHER PATENTS, PENDING PATENT APPLICATIONS AND PUBLICATIONS

The disclosures of the following four (4) U.S. patents in their entirety hereby are totally incorporated herein by reference:

U.S. Pat. No. 7,010,236 B2, issued to Kohji Shinkawa et al., granted 7 Mar. 2006, entitled “Equipment unit with imperceptible information recorded thereon being used with an image forming device and an image forming device comprising the same”;

U.S. Pat. No. 6,965,744 B1, issued to Edward M. Housel, granted 15 Nov. 2005, entitled “Method and apparatus for toner-driven printer control”;

U.S. Pat. No. 6,236,816 B1, issued to Volker Warbus et al., granted 22 May 2001, entitled “Printing or duplicating apparatus optionally operating with magnetic or non magnetic toner”; and

U.S. Pat. No. 5,760,928, issued to Eiichi Motoyama et al., granted 2 Jun. 1998, entitled “Image forming apparatus utilizing plural image forming methods and recording agent color detection”.

### BACKGROUND OF THE INVENTION

In the past, there has been a reliance on image forming device users to follow procedures for installing the correct type of consumables such as a toner apparatus container. This process is prone to operator error. Such errors can result in poor machine performance, downtime, service calls and general dissatisfaction and revenue loss.

In some cases, an operator provides information to the machine to confirm some characteristic of the product. For example, some reprographic machines can detect the size of the paper added to a paper tray. In this case, the operator provides confirmation of the size of the paper. However, other information about the paper (such as bond, color, number of sheets, gloss, and manufacturer) are not detected or requested of the operator. This information would be useful for the optimal performance of the machine.

Thus, there is a need for the present invention.

### BRIEF SUMMARY OF THE INVENTION

In a first aspect of the invention, there is described an image forming device including a document scanner to scan a document, the image forming device arranged to identify a detached apparatus based on a detecting by the document scanner.

In a second aspect of the invention, there is described an image forming device including a document scanner, the image forming device arranged to identify a detached apparatus based on a detecting by an included sensor.

In a third aspect of the invention, there is described an image forming device including a document scanner to scan a document based on a document scanning signal, the image forming device arranged to identify a detached apparatus based on a detecting by both the document scanner and an included sensor.

In a fourth aspect of the invention, there is described an image forming device arranged to scan a document based on an included document scanner detecting a scanning signal passing through an included scanning platen, the image forming device arranged to identify a detached apparatus based on a detecting comprising an included sensor sensing signals that do not pass through the document scanning platen.

In a fifth aspect of the invention, there is described an image forming device arranged to identify a detached apparatus based on a detecting comprising both an included document scanner detecting signals that pass through an included scanning platen and an included sensor sensing signals that do not pass through the scanning platen.

In a sixth aspect of the invention, there is described an image forming device comprising a marking device arranged to identify a detached apparatus based on a detecting comprising an included sensor sensing signals.

In a seventh aspect of the invention, there is described an image forming device arranged to identify a detached apparatus and to provide one or more signals based on the detached apparatus, the one or more signals including at least a user signal based on when the detached apparatus can be attached to or used with the image forming device.

In an eighth aspect of the invention, there is described a method to identify a detached apparatus in an image forming device, the image forming device including a document scanner to scan a document, the method comprising a detecting by the document scanner.

In a ninth aspect of the invention, there is described a method to identify a detached apparatus in an image forming device, the image forming device including a document scanner, the method comprising a detecting by an included sensor.

In a tenth aspect of the invention, there is described a method to identify a detached apparatus in an image forming device, the image forming device including a document scanner to scan a document, the method comprising a detecting by both the document scanner and an included sensor.

In an eleventh aspect of the invention, there is described a method to identify a detached apparatus in an image forming device, the image forming device arranged to scan a document based on an included document scanner detecting a scanning signal passing through an included scanning platen, the method including a detecting comprising an included sensor sensing signals that do not pass through the scanning platen.

In a twelfth aspect of the invention, there is described a method to identify a detached apparatus in an image forming device, the image forming device including a scanning platen, the method including a detecting comprising both an included document scanner detecting signals that pass through the scanning platen and an included sensor sensing signals that do not pass through the scanning platen.

In a thirteenth aspect of the invention, there is described a method to identify a detached apparatus in a marking device, the marking device including a sensor the method comprising a detecting comprising the sensor sensing signals.

In a fourteenth aspect of the invention, there is described a method for an image forming device to identify a detached apparatus and to provide one or more signals based on the detached apparatus, the one or more signals including at least a user signal based on when the detached apparatus can be attached to or used with the image forming device.

### BRIEF DESCRIPTION OF THE SEVERAL VIEWS OF THE DRAWING

FIGS. 1-6 generally depict image forming devices respectively depicted by reference numbers 100, 200, 300, 400, 500, 600 that are arranged in accordance with a method and process depicted by reference number 700 to identify a detached apparatus 2 and to provide one or more signals 81-83 based on the detached apparatus 2, the one or more signals 81-83 including at least a user signal 81 based on when the detached apparatus 2 can be attached to or used with the image forming device 100-600.

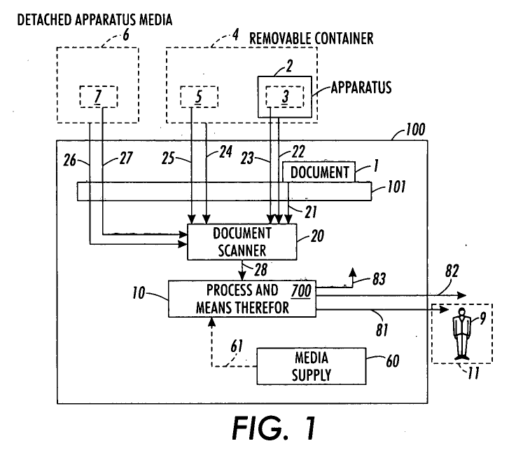

Also depicted in FIGS. 1-6 is an optional apparatus container 4.

Also depicted in FIGS. 1-6 is an optional detached apparatus media 6.

Referring generally to FIGS. 1-6, in various embodiments the detached apparatus 2, the apparatus container 4 and the detached apparatus media 6 are detected by the image forming device 100-600.

Still referring to FIGS. 1-6, in various embodiments the detached apparatus 2 optionally includes an apparatus recorded information 3.

Also, in various embodiments the apparatus container 4 depicted in FIGS. 1-6 optionally includes a container recorded information 5.

Also, in various embodiments the detached apparatus media 6 depicted in FIGS. 1-6 optionally includes an apparatus media recorded information 7.

Referring generally to FIGS. 1-6, in various embodiments the apparatus recorded information 3, the container recorded information 5 and the apparatus media recorded information 7 are arranged, configured and embodied to convey, transmit, comprise or represent information based on, corresponding, pertaining or related to the detached apparatus 2 including, but not limited to, any of the following: manufacturer, distributor, manufacturing lot, manufacturing location, manufactured date, expiration date, product life date, shipping information, import information, export information, warranty information, option information, configuration information, application information, installation information, usage information, cleaning information, service information, repair information, replacement information, release information, version information, product type, product class, product name, product identity, model number, universal product code (“UPC”) number, maintenance information, compatibility information, serial number, size, color, material, composition, thickness, weight, or other information.

In various embodiments, the apparatus recorded information 3, the container recorded information 5 and the apparatus media recorded information 7 depicted in FIGS. 1-6 are arranged, configured and embodied to be detectable by the image forming device 100-600.

In various embodiments, the apparatus recorded information 3, the container recorded information 5 and the apparatus media recorded information 7 depicted in FIGS. 1-6 comprise any one or more of barcodes, Q-codes, symbols, letters, numbers, characters, markings or other indicia that are capable of being detected by the image forming device 100-600.

Still referring to FIGS. 1-6, in various embodiments the apparatus recorded information 3, the container recorded information 5 and the apparatus media recorded information 7 are exclusively machine-detectable and thus not capable of being observed, perceived, detected, read, received or discerned by the human naked eye, and, conveying, transmitting, or representing

Referring still to FIGS. 1-6, in addition and supplemental to being machine-detectable and machine-readable by the image forming device 100-600, in various embodiments the apparatus recorded information 3, the container recorded information 5 and the apparatus media recorded information 7 are further arranged, configured and embodied also to be human detectable and thus visible to the human naked eye. In one embodiment, for example, the apparatus recorded information 3, the container recorded information 5 and the apparatus media recorded information 7 comprise barcode symbols which barcode symbols are both, first, machine-detectable by a suitable barcode detecting means or software and, second, visible to and detectable by the human naked eye.

In various embodiments, the apparatus recorded information 3, the container recorded information 5 and the apparatus media recorded information 7 depicted in FIGS. 1-6 comprise human-visible-and-machine-detectable markings, letters, numbers or symbols.

Still referring to FIGS. 1-6, in various embodiments the apparatus recorded information 3, the container recorded information 5 and the apparatus media recorded information 7 are machine-detectable by the image forming device 100-600 and, in addition, a portion, a part, a few, or some, though perhaps not totally all, of these same recorded information items 3, 5 and 7 also are human detectable and thus visible to the human naked eye.

In one embodiment, for example, the aforementioned apparatus recorded information 3, the container recorded information 5 and the apparatus media recorded information 7 depicted in FIGS. 1-6 are based on the teachings of the aforementioned U.S. Pat. No. 7,010,236 B2, issued to Kohji Shinkawa et al., granted 7 Mar. 2006, entitled “Equipment unit with imperceptible information recorded thereon being used with an image forming device and an image forming device comprising the same” (hereinafter “Shinkawa”), the full, absolute and complete disclosure of which Shinkawa patent herein is incorporated by reference verbatim, and with the same effect as though such disclosure were hereinat presented and reproduced in its entirety. See, for example, Shinkawa from column 2, line 44 to column 4, line 20; and column 8, lines 3-7.

In one embodiment, for example, the aforementioned apparatus recorded information 3, the container recorded information 5 and the apparatus media recorded information 7 depicted in FIGS. 1-6 are based on magnetic ink character recognition (“MICR”) technology, as described in the aforementioned U.S. Pat. No. 6,236,816 B1, issued to Volker Warbus et al., granted 22 May 2001, entitled “Printing or duplicating apparatus optionally operating with magnetic or non magnetic toner” (hereinafter “Warbus”), the full, absolute and complete disclosure of which Warbus patent herein is incorporated by reference verbatim, and with the same effect as though such disclosure were hereinat presented and reproduced in its entirety.

In one embodiment, for example, the aforementioned apparatus recorded information 3, the container recorded information 5 and the apparatus media recorded information 7 depicted in FIGS. 1-6 are based on the well-known and common Radio Frequency Identification (“RFID”) tag technology.

In one embodiment, for example, the aforementioned apparatus recorded information 3, the container recorded information 5 and the apparatus media recorded information 7 depicted in FIGS. 1-6 are based on the well-known and common machine vision technology.

Referring still to FIGS. 1-6, in various embodiments the detached apparatus 2 comprises any of the following: ink cartridge; solid ink stick; toner casing; toner cartridge; toner bottle; toner apparatus container; photosensitive cartridge; photosensitive drum; photosensitive belt; charging unit; laser irradiation unit; developing cartridge; transfer unit; fixing unit; cleaning unit; one or more media sheets; replacement part; attachable part; or other items that can be attached to or used with the image forming device 100-600 of FIGS. 1-6.

Still referring to FIGS. 1-6, in various embodiments the apparatus container 4 comprises any of the following: shipping apparatus container for the detached apparatus 2; shipping box or carton for the detached apparatus 2; shipping packaging for the detached apparatus 2; dispenser for the detached apparatus 2; cartridge for the detached apparatus 2; replenishing bottle for the detached apparatus 2; dispensing bottle for the detached apparatus 2; or other vessel or container for the detached apparatus 2.

Referring yet still to FIGS. 1-6, in various embodiments the detached apparatus media 6 comprises any of the following: packaging insert for the detached apparatus 2; product literature for the detached apparatus 2; bill of lading; shipping list; shipping bill; shipping invoice; shipping literature for the detached apparatus 2; user's guide, manual or instructions for the detached apparatus 2; installation guide, manual or instructions for the detached apparatus 2; maintenance guide, manual or instructions for the detached apparatus 2; warranty media for the detached apparatus 2; service media for the detached apparatus 2; or other media based on or related to the detached apparatus 2.

In one embodiment, the detached apparatus 2 comprises one or more media sheets and the FIGS. 1-6 image forming device 100-600 is arranged to provide a user signal 81 based on when the one or more media sheets can be disposed in or added to the depicted included media supply means 60.

In one embodiment, the image forming device 100-600 depicted in FIGS. 1-6 is further arranged to provide a remote service signal 82 based on when it is not possible for the detached apparatus 2 to be attached to the image forming device.

In one embodiment, the image forming device 100-600 depicted in FIGS. 1-6 is further arranged to provide an internal adjusting signal 83 that is based on the detached apparatus 2.

For good understanding, the method and process 700 is described in greater detail in connection with FIG. 7 as presented hereinbelow.

Referring now to FIG. 1, there is depicted an image forming device 100 including a document scanner 20 and where the image forming device 100 is arranged to identify the detached apparatus 2 based on a detecting by the document scanner 20.

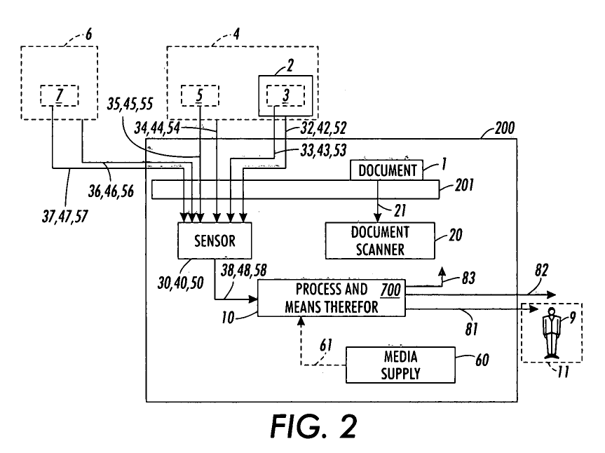

Now referring to FIG. 2, there is depicted an image forming device 200 including a document scanner 20 and a sensor variously depicted by reference numbers 30, 40, 50 and where the image forming device 200 is arranged to identify the detached apparatus 2 based on a detecting by the sensor 30, 40, 50.

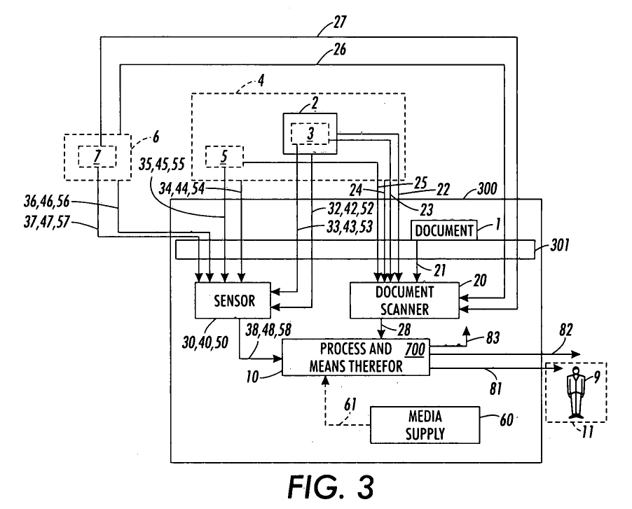

Referring now to FIG. 3, there is depicted an image forming device 300 including a document scanner 20 and a sensor 30, 40, 50 and where the image forming device 300 is arranged to identify the detached apparatus 2 based on a detecting by both the document scanner 20 and the sensor 30, 40, 50.

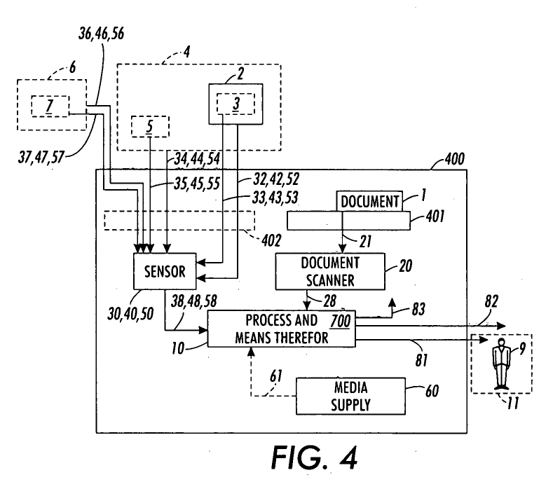

Now referring to FIG. 4, there is depicted an image forming device 400 including a document scanner 20 to scan a document 1 based on a scanning signal 21 that passes through an included scanning platen 401 and further including a sensor 30, 40, 50 where the image forming device 400 is arranged to identify the detached apparatus 2 based on the sensor 30, 40, 50 detecting signals 32-37, 42-47, 52-57 that do not pass through the scanning platen 401.

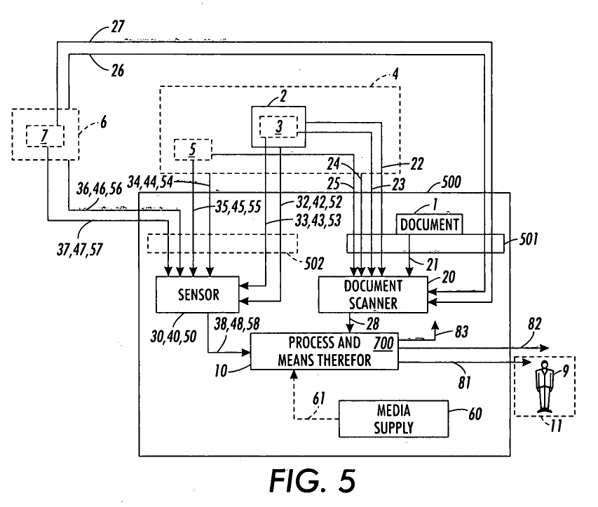

Referring now to FIG. 5, there is depicted an image forming device 500 including a document scanner 20 and a sensor 30, 40, 50 and where the image forming device 500 is arranged to identify the detached apparatus 2 based on a detecting by both the document scanner 20 detecting signals 22-27 that pass through an included scanning platen 501 and the sensor 30, 40, 50 sensing signals 32-37, 42-47, 52-57 that do not pass through the scanning platen 501.

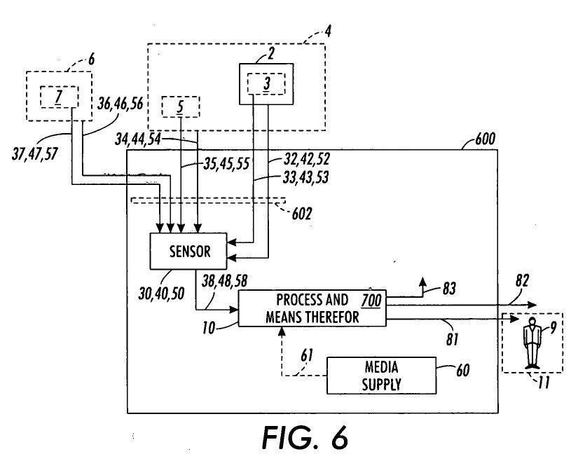

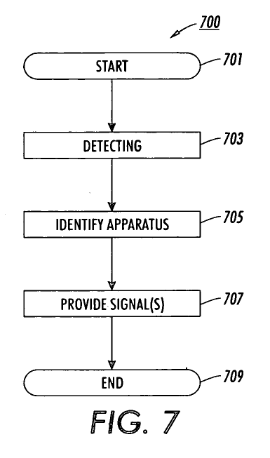

Now referring to FIG. 6, there is depicted an image forming device comprising a marking device 600 that is devoid of a document scanner 20 and that includes a sensor 30, 40, 50 and where the image forming device 600 is arranged to identify the detached apparatus 2 based on a detecting by the sensor 30, 40, 50.

Referring now to FIG. 7, there is depicted the detached apparatus identifying method and process 700, in accordance with the present invention.

### DETAILED DESCRIPTION OF THE INVENTION

Referring now to FIG. 1 there is depicted a first embodiment 100 of an image forming device including a detached apparatus identifying method 700, in accordance with the present invention. There is shown an image forming device 100 including a document scanner 20 arranged to scan a document 1 based on a scanning signal 21. The image forming device 100 is arranged to identify a depicted detached apparatus 2 in accordance with an included process or method 700. For good understanding, the process or method 700 is more fully described hereinafter including, but not limited to, in connection with FIG. 7.

As shown, the document scanner 20 provides an output signal 28 to any of apparatus, methods, processes and systems internal or external to the image forming device 100 including, but not limited to, the depicted means 1 0 for performing the process 700.

As shown, the means 10 comprises any arrangement or software, hardware, or any combination of software and hardware, as needed to perform the process 700.

As shown, the image forming device 100 includes a document scanning platen 101 and a media supply 60. In one embodiment, the media supply 60 provides a corresponding media supply signal 61 to the process 700.

Referring still to FIG. 1, in one embodiment the detached apparatus 2 includes an apparatus recorded information 3.

Also, in one embodiment the detached apparatus 2 is arranged to be disposed or received in an optional apparatus container 4.

Further, in one embodiment the detached apparatus 2 is arranged to be disposed or received in an optional apparatus container 4 and the apparatus container 4 includes an apparatus container recorded information 5.

Also, in one embodiment there is provided an optional detached apparatus media 6.

Further, in one embodiment there is provided an optional detached apparatus media 6 and the detached apparatus media 6 includes an apparatus media recorded information 7.

Still referring to FIG. 1, there is shown a human user or operator 9.

In one embodiment, the user 9 is located within a physical space or area depicted by reference number 11.

In one embodiment, the area 11 is local, near, adjacent or proximate to the image forming device 100.

As shown in FIG. 1, the provided signals 81-83 are based on the detached apparatus 2.

A user signal 81 conveys, transmits, propagates or indicates information based on the detached apparatus 2 to the user 9.

In one embodiment, the user signal 81 is based on when the detached apparatus 2 can be attached to or used with the image forming device 100.

In one embodiment, the detached apparatus 2 comprises one or more media sheets and the user signal 81 is based on when the one or more media sheets can be disposed in or added to the depicted included media supply means 60.

Referring still to FIG. 1, in one embodiment a further signal 82 conveys, transmits, propagates or indicates information based on the detached apparatus 2 to any of apparatus, systems, organizations and individuals located external to the image forming device 100. In one embodiment, the signal 82 is received by any of users, maintenance personnel or organizations, service personnel or organizations, distributing personnel or organizations, and manufacturing personnel or organizations in connection with any of the image forming device 100 and the detached apparatus 2.

In one embodiment, the signal 82 comprises a remote service signal based on when it is not possible for the detached apparatus 2 to be attached to the image forming device 100.

Still referring to FIG. 1, in one embodiment a still further signal 83 conveys, transmits, propagates or indicates information based on the detached apparatus 2 to any of apparatus, methods, processes and systems internal to the image forming device 100.

In one embodiment, the signal 83 comprises an internal adjusting signal that is based on the detached apparatus 2.

Referring now to FIG. 2 there is depicted a second embodiment 200 of an image forming device including a detached apparatus identifying method 700, in accordance with the present invention. There is shown an image forming device 200 including a document scanner 20 arranged to scan a document 1 based on a scanning signal 21. The image forming device 200 also includes a sensor variously depicted by reference numbers 30, 40, 50.

In one embodiment the sensor, depicted by reference number 30, is arranged to sense human-visible signals 32-37.

In another embodiment the sensor, depicted by reference number 40, is arranged to sense human-non-visible signals 42-47.

Still referring to FIG. 2, in one embodiment the sensor 40 is similar or identical to the sensor 11 as described in the aforementioned Shinkawa et al. patent, U.S. Pat. No. 7,010,236 B2 at column 4, lines 42-64, which Shinkawa patent is incorporated by reference herein.

Referring still to FIG. 2, in one embodiment the sensor 40 is an RFID detector.

In a further embodiment the sensor, depicted by reference number 50, is arranged to sense signals 52-57 comprising both human-visible and human-non-visible signals.

The image forming device 200 is arranged to identify a depicted detached apparatus 2 in accordance with the included process or method 700.

As shown in FIG. 2, the sensor 30, 40 or 50, as the case may be, provides a corresponding output signal, the aforementioned output signal being depicted by the corresponding reference number 38, 48 or 58, as the case may be, to any of apparatus, methods, processes and systems internal or external to the image forming device 200 including, but not limited to, the software, hardware, or a combination of software and hardware, as needed to perform the process 700, the aforementioned software, hardware, or both, being collectively depicted by reference number 10.

As shown, the image forming device 200 includes a platen 201 and a media supply 60. In one embodiment, the media supply 60 provides a corresponding media supply signal 61 to the process 700.

Referring now to FIG. 3 there is depicted a third embodiment 300 of an image forming device including a detached apparatus identifying method 700, in accordance with the present invention. There is shown an image forming device 300 including a document scanner 20 arranged to scan a document 1 based on a scanning signal 21. The image forming device 300 also includes a sensor variously depicted by reference numbers 30, 40, 50 arranged to sense human-visible signals 32-37, human-non-visible signals 42-47, or signals 52-57 comprising both human-visible and human-non-visible signals. In accordance with the depicted included process 700, the image forming device 300 is arranged to identify a depicted detached apparatus 2 based on scanning the detached apparatus 2 by the document scanner 20; or sensing the detached apparatus 2 by the sensor 30, 40, 50; or scanning the detached apparatus 2 by the document scanner 20 and sensing the detached apparatus 2 by the sensor 30, 40, 50.

As shown, the image forming device 300 includes a platen 301 and a media supply 60. In one embodiment, the media supply 60 provides a corresponding media supply signal 61 to the process 700.

Referring now to FIG. 4 there is depicted a fourth embodiment 400 of an image forming device including a detached apparatus identifying method 700, in accordance with the present invention. There is depicted an image forming device 400 arranged to scan a document 1 based on a scanning signal 21 passing through an included document scanning platen 401 to be received by an included document scanner 20. In accordance with the depicted included process 700, the image forming device 400 is arranged to identify a depicted detached apparatus 2 based on sensing human-visible signals 32-37, human-non-visible signals 42-47, or signals 52-57 comprising both human-visible and human-non-visible signals that are sensed by the included sensor respectively depicted by reference numbers 30, 40, 50. As shown, the sensing signals 32-37, 42-47, 52-57 are received by the sensor 30, 40, 50 without passing through the document scanning platen 401.

As shown, the image forming device 400 includes a media supply 60. In one embodiment, the media supply 60 provides a corresponding media supply signal 61 to the process 700.

As shown, in one embodiment the sensing signals 32-37, 42-47, 52-57 pass through an included sensing platen 402 to be received by the sensor 30, 40, 50.

Referring now to FIG. 5 there is depicted a fifth embodiment 500 of an image forming device including a detached apparatus identifying method 700, in accordance with the present invention. There is shown an image forming device 500 including a document scanner 20 arranged to scan a document 1 based on a scanning signal 21. The image forming device 500 also includes a sensor variously depicted by reference numbers 30, 40, 50 arranged to sense human-visible signals 32-37, human-non-visible signals 42-47, or signals 52-57 comprising both human-visible and human-non-visible signals. In accordance with the depicted included process 700, the image forming device 500 is arranged to identify a depicted detached apparatus 2 based on scanning the detached apparatus 2 by the document scanner 20; or sensing the detached apparatus 2 by the sensor 30, 40, 50; or scanning the detached apparatus 2 by the document scanner 20 and sensing the detached apparatus 2 by the sensor 30, 40, 50. As depicted, the scanning signals 21-27 that are detected by the document scanner 20 pass through an included document scanning platen 501 to be received by the document scanner 20, whereas the sensing signals 32-37, 42-47, 52-57 are sensed by the sensor 30, 40, 50 without passing through the document scanning platen 501.

As shown, in one embodiment the sensing signals 32-37, 42-47, 52-57 pass through an included platen 502 to be received by the sensor 30, 40, 50.

Referring now to FIG. 6 there is depicted a sixth embodiment 600 of an image forming device including a detached apparatus identifying method 700, in accordance with the present invention. There is shown a marking device 600 arranged to identify a detached apparatus 2 in accordance with the depicted included process 70 based on a sensing signals 32-37, 42-47, 52-57 that are received by an included sensor 30, 40, 50. As depicted, in one embodiment the marking device 600 is devoid of any document scanner similar or identical to the document depicted by reference number 20 and described herein in connection with FIGS. 1-5. In various embodiments, the sensor 30, 40, 50 is arranged to sense human-visible signals 32-37; or human-non-visible signals 42-47; or signals 52-57 comprising both human-visible and human-non-visible signals. As depicted, in one embodiment the sensing signals 32-37, 42-47, 52-57 pass through an optional included platen 602 to be received by the sensor 30, 40, 50.

Referring now to FIG. 7, there is depicted a flow diagram 700 for an image forming device 100-600 to identify a detached apparatus, in accordance with the present invention.

The method begins at step 701, designated “start”, and then proceeds to step 703, designated “detecting”.

In the detecting step 703 the image forming device 100-600 performs a detecting.

With cross-reference to FIG. 1, in one embodiment the image forming device comprises the FIG. 1 image forming device 100 and the detecting step 703 comprises a detecting by the document scanner 20.

With continued cross-reference to the FIG. 1 image forming device 100, the following seven (7) sentences apply to the detecting step 703:

First, in one embodiment the detecting step 703 includes the document scanner 20 scanning the detached apparatus 2.

Second, in one embodiment the detached apparatus 2 includes an apparatus recorded information 3 and the detecting step 703 includes the document scanner 20 scanning the apparatus recorded information 3.

Third, in one embodiment the detached apparatus 2 is arranged to be disposed or received in an apparatus container 4 and the detecting step 703 includes the document scanner 20 scanning the apparatus container 4.

Fourth, in one embodiment the detached apparatus 2 is arranged to be disposed or received in an apparatus container 4 and the apparatus container 4 includes an apparatus container recorded information 5 and the detecting step 703 includes the document scanner 20 scanning the apparatus container recorded information 5.

Fifth, in one embodiment the detecting step 703 includes the document scanner 20 scanning 26 an included detached apparatus media 6.

Sixth, in one embodiment the detecting step 703 includes the document scanner 20 scanning 27 an apparatus media recorded information 7 that is comprised in an included detached apparatus media 6.

Seventh, in one embodiment the detecting step 703 includes the document scanner 20 detecting both human-visible and non-human-visible signals 22-27.

With cross-reference to FIG. 2, in one embodiment the image forming device comprises the FIG. 2 image forming device 200 and the detecting step 703 comprises a detecting by the included sensor 30, 40, 50.

With continued cross-reference to the FIG. 2 image forming device 200, the following eighth (8) sentences apply to the detecting step 703:

First, in one embodiment the detecting step 703 includes sensing the detached apparatus 2 by the sensor 30, 40, 50.

Second, in one embodiment the detached apparatus 2 includes an apparatus recorded information 3 and the detecting step 703 includes sensing the apparatus recorded information 3 by the sensor 30, 40, 50.

Third, in one embodiment the detached apparatus 2 is arranged to be disposed or received in an apparatus container 4 and the detecting step 703 includes sensing the apparatus container 4 by the sensor 30, 40, 50.

Fourth, in one embodiment the detached apparatus 2 is arranged to be disposed or received in an apparatus container 4 and the apparatus container 4 includes an apparatus container recorded information 5 and the detecting step 703 includes sensing the apparatus container recorded information 5 by the sensor 30, 40, 50.

Fifth, in one embodiment the detecting step 703 the sensor 30, 40, 50 sensing 36, 46, 56 an included detached apparatus media 6.

Sixth, in one embodiment the detecting step 703 includes the sensor 30, 40, 50 sensing 37, 47, 57 an apparatus media recorded information 7 that is comprised in an included detached apparatus media 6.

Seventh, in one embodiment the image forming device 200 is arranged to scan a document 1 based on a document scanning signal 21 passing through an included platen 201 to be received by the document scanner 20 and the detecting step 703 includes the sensor 30, 40, 50 sensing signals 32-37, 42-47, 52-57 that pass through the same platen 201.

Eighth, in one embodiment the detecting step 703 includes the sensor 30, 40, 50 sensing human-visible signals 32-37; or human-non-visible signals 42-47; or signals 52-57 comprising both human-visible and human-non-visible signals.

With cross-reference to FIG. 3, in one embodiment the image forming device comprises the FIG. 3 image forming device 300 and the detecting step 703 comprises a detecting by both the document scanner 20 and the included sensor 30, 40, 50.

With continued cross-reference to the FIG. 3 image forming device 300, the following eight (8) sentences apply to the detecting step 703:

First, in one embodiment the detecting step 703 includes scanning the detached apparatus 2 by the document scanner 20; or sensing the detached apparatus 2 by the sensor 30, 40, 50; or both scanning the detached apparatus 2 by the document scanner 20 and sensing the detached apparatus 2 by the sensor 30, 40, 50.

Second, in one embodiment the detached apparatus 2 includes an apparatus recorded information 3 and the detecting step 703 includes scanning the apparatus recorded information 3 by the document scanner 20; or sensing the apparatus recorded information 3 by the sensor 30, 40, 50; or both scanning the apparatus recorded information 3 by the document scanner and sensing the apparatus recorded information 3 by the sensor 30, 40, 50.

Third, in one embodiment the detached apparatus 2 is arranged to be disposed or received in an apparatus container 4 and the detecting step 703 includes scanning the apparatus container 4 by the document scanner 20; or sensing the apparatus container 4 by the sensor 30, 40, 50; or both scanning the apparatus container 4 by the document scanner 20 and sensing the apparatus container 4 by the sensor 30, 40, 50.

Fourth, in one embodiment the detached apparatus 2 is arranged to be disposed or received in an apparatus container 4 and the apparatus container 4 includes an apparatus container recorded information 5 and the detecting step 703 includes scanning the apparatus container recorded information 5 by the document scanner 20; or sensing the apparatus container recorded information 5 by the sensor 30, 40, 50; or both scanning the apparatus container recorded information 5 by the document scanner 20 and sensing the apparatus container recorded information 5 by the sensor 30, 40, 50.

Fifth, in one embodiment a detached apparatus media 6 is provided and the detecting step 703 includes scanning the detached apparatus media 6 by the document scanner 20; or sensing the detached apparatus media 6 by the sensor 30, 40, 50; or both scanning the detached apparatus media 6 by the document scanner 20 and sensing the detached apparatus media 6 by the sensor 30, 40, 50.

Sixth, in one embodiment a detached apparatus media 6 is provided and the detached apparatus media 6 includes an apparatus media recorded information 7, and the detecting step 703 includes scanning the apparatus media recorded information 7 by the document scanner 20; or sensing the apparatus media recorded information 7 by the sensor 30, 40, 50; or both scanning the apparatus media recorded information 7 by the document scanner 20 and sensing the apparatus media recorded information 7 by the sensor 30, 40, 50.

Seventh, in one embodiment the detecting step 703 includes the document scanner 20 detecting signals 21-27 that pass through an included platen 201 and further includes the sensor 30, 40, 50 sensing signals 32-37, 42-47, 52-57 that pass through the platen 201.

Eighth, in one embodiment the detecting step 703 includes the sensor 30, 40, 50 sensing human-visible signals 32-37; or human-non-visible signals 42-47; or signals 52-57 comprising both human-visible and human-non-visible signals.

With cross-reference to FIG. 4, in one embodiment the image forming device comprises the FIG. 4 image forming device 400 and the detecting step 703 comprises an included sensor 30, 40, 50 sensing signals 32-37, 42-47, 52-57 that do not pass through the included scanning platen 401.

With continued cross-reference to the FIG. 4 image forming device 400, the following eight (8) sentences apply to the detecting step 703:

First, in one embodiment the detecting step 703 includes sensing the detached apparatus 2 by the sensor 30, 40, 50.

Second, in one embodiment the detached apparatus 2 includes an apparatus recorded information 3 and the detecting step 703 includes the sensor 30, 40, 50 sensing the apparatus recorded information 3.

Third, in one embodiment the detached apparatus 2 is arranged to be disposed or received in an apparatus container 4 and the detecting step 703 includes the sensor 30, 40, 50 sensing the apparatus container 4.

Fourth, in one embodiment the detached apparatus 2 is arranged to be disposed or received in an apparatus container 4 and the apparatus container 4 includes an apparatus container recorded information 5 and the detecting step 703 includes the sensor 30, 40, 50 sensing the apparatus container recorded information 5.

Fifth, in one embodiment the detecting step 703 the sensor 30, 40, 50 sensing 36, 46, 56 an included detached apparatus media 6.

Sixth, in one embodiment the detecting step 703 includes the sensor 30, 40, 50 sensing 37, 47, 57 an apparatus media recorded information 7 that is comprised in an included detached apparatus media 6.

Seventh, in one embodiment the detecting step 703 includes the sensor 30, 40, 50 sensing signals 32-37, 42-47, 52-57 that pass through an included sensing platen 402.

Eighth, in one embodiment the detecting step 703 includes the sensor 30, 40, 50 sensing human-visible signals 32-37; or human-non-visible signals 42-47; or signals 52-57 comprising both human-visible and human-non-visible signals.

With cross-reference to FIG. 5, in one embodiment the image forming device comprises the FIG. 5 image forming device 500 and the detecting step 703 comprises the document scanner 20 detecting signals 22-27 that pass through an included scanning platen 501 and an included sensor 30, 40, 50 sensing signals 32-37, 42-47, 52-57 that do not pass through the scanning platen 501.

With continued cross-reference to the FIG. 5 image forming device 500, the following eight (8) sentences apply to the detecting step 703:

First, in one embodiment the detecting step 703 includes scanning the detached apparatus 2 by the document scanner 20; or sensing the detached apparatus 2 by the sensor 30, 40, 50; or both scanning the detached apparatus 2 by the document scanner 20 and sensing the detached apparatus 2 by the sensor 30, 40, 50.

Second, in one embodiment the detached apparatus 2 includes an apparatus recorded information 3 and the detecting step 703 includes scanning the apparatus recorded information 3 by the document scanner 20; or sensing the apparatus recorded information 3 by the sensor 30, 40, 50; or both scanning the apparatus recorded information 3 by the document scanner 20 and sensing the apparatus recorded information 3 by the sensor 30, 40,50.

Third, in one embodiment the detached apparatus 2 is arranged to be disposed in a corresponding apparatus container 4 and the detecting step 703 includes scanning the apparatus container 4 by the document scanner 20; or sensing the apparatus container 4 by the sensor 30, 40, 50; or both scanning the apparatus container 4 by the document scanner 20 and sensing the detached apparatus 2 by the sensor 30, 40, 50.

Fourth, in one embodiment the detached apparatus 2 is arranged to be disposed in a corresponding apparatus container 4 and the apparatus container 4 includes an apparatus container recorded information 5 and the detecting step 703 includes scanning the apparatus container recorded information 5 by the document scanner 20; or sensing the apparatus container recorded information 5 by the sensor 30, 40, 50; or both scanning the apparatus container recorded information 5 by the document scanner 20 and sensing the apparatus container recorded information 5 by the sensor 30, 40, 50.

Fifth, in one embodiment in one embodiment a detached apparatus media 6 is provided and the detecting step 703 includes scanning the detached apparatus media 6 by the document scanner 20; or sensing the detached apparatus media 6 by the sensor 30, 40, 50; or both scanning the detached apparatus media 6 by the document scanner 20 and sensing the detached apparatus media 6 by the sensor 30, 40, 50.

Sixth, in one embodiment in one embodiment a detached apparatus media 6 is provided and the detached apparatus media 6 includes an apparatus media recorded information 7, and the detecting step 703 includes scanning the apparatus media recorded information 7 by the document scanner 20; or sensing the apparatus media recorded information 7 by the sensor 30, 40, 50; or both scanning the apparatus media recorded information 7 by the document scanner 20 and sensing the apparatus media recorded information 7 by the sensor 30, 40, 50.

Seventh, in one embodiment the detecting step 703 includes the sensor 30, 40, 50 detecting signals 32-37, 42-47, 52-57 that pass through an included sensing platen 502.

Eighth, in one embodiment the detecting step 703 includes the sensor 30, 40, 50 detecting human-visible signals 32-37; or human-non-visible signals 42-47; or signals 52-57 comprising both human-visible and human-non-visible signals.

With cross-reference to FIG. 6, in one embodiment the image forming device comprises the FIG. 6 marking device 600 and the detecting step 703 comprises an included sensor 30, 40, 50 sensing signals 32-37, 42-47, 52-57.

With continued cross-reference to the FIG. 5 image forming device 500, the following seven (7) sentences apply to the detecting step 703:

First, in one embodiment the detecting step 703 includes sensing the detached apparatus 2 by the sensor 30, 40, 50.

Second, in one embodiment the detached apparatus 2 includes an apparatus recorded information 3 and the detecting step 703 includes sensing the apparatus recorded information 3 by the sensor 30, 40, 50.

Third, in one embodiment the detached apparatus 2 is arranged to be disposed or received in an apparatus container 4 and the detecting step 703 includes sensing the apparatus container 4 by the sensor 30, 40, 50.

Fourth, in one embodiment the detached apparatus 2 is arranged to be disposed or received in an apparatus container 4 and the apparatus container 4 includes an apparatus container recorded information 5 and the detecting step 703 includes sensing the apparatus container recorded information 5 by the sensor 30, 40, 50.

Fifth, in one embodiment the detecting step 703 the sensor 30, 40, 50 sensing 36, 46, 56 an included detached apparatus media 6.

Sixth, in one embodiment the detecting step 703 includes the sensor 30, 40, 50 sensing 37, 47, 57 an apparatus media recorded information 7 that is comprised in an included detached apparatus media 6.

Seventh, in one embodiment the detecting step 703 includes the sensor 30, 40, 50 sensing human-visible signals 32-37; or human-non-visible signals 42-47; or signals 52-57 comprising both human-visible and human-non-visible signals.

After completing the detecting step 703, the process 700 goes to step 705, designated “identify apparatus”.

In the apparatus identifying step 705, the image forming device 100-600 identifies the detached apparatus 2 based on the preceding detecting step 703.

The following twenty-seven (27) sentences apply to the apparatus identifying step 705.

First, in one embodiment the apparatus identifying step 705 is based on the document scanner 20 scanning the detached apparatus 2.

Second, in one embodiment the apparatus identifying step 705 is based on the sensor 30, 40, 50 sensing the detached apparatus 2.

Third, in one embodiment the apparatus identifying step 705 is based on both the document scanner 20 scanning and the sensor 30, 40, 50 sensing the detached apparatus 2.

Fourth, in one embodiment the detached apparatus 2 includes an apparatus recorded information 3 and the apparatus identifying step 705 is based on the document scanner 20 scanning the apparatus recorded information 3.

Fifth, in one embodiment the detached apparatus 2 includes an apparatus recorded information 3 and the apparatus identifying step 705 is based on the sensor 30, 40, 50 sensing the apparatus recorded information 3.

Sixth, in one embodiment the detached apparatus 2 includes an apparatus recorded information 3 and the apparatus identifying step 705 is based on both the document scanner 20 scanning and the sensor 30, 40, 50 sensing the apparatus recorded information 3.

Seventh, in one embodiment the detached apparatus 2 includes an apparatus shape and the apparatus identifying step 705 is based on the document scanner 20 scanning the apparatus shape.

Eighth, in one embodiment the detached apparatus 2 includes an apparatus shape and the apparatus identifying step 705 is based on the sensor 30, 40, 50 sensing the apparatus shape.

Ninth, in one embodiment the detached apparatus 2 includes an apparatus shape and the apparatus identifying step 705 is based on both the document scanner 20 scanning and the sensor 30, 40, 50 sensing the apparatus shape.

Tenth, in one embodiment the detached apparatus 2 is arranged to be disposed or received in an apparatus container 4 and the apparatus identifying step 705 is based on the document scanner 20 scanning the apparatus container 4.

Eleventh, in one embodiment the detached apparatus 2 is arranged to be disposed or received in an apparatus container 4 and the apparatus identifying step 705 is based on the sensor 30, 40, 50 sensing the apparatus container 4.

Twelfth, in one embodiment the detached apparatus 2 is arranged to be disposed or received in an apparatus container 4 and the apparatus identifying step 705 is based on both the document scanner 20 scanning and the sensor 30, 40, 50 sensing the apparatus container 4.

Thirteenth, in one embodiment the detached apparatus 2 is arranged to be disposed or received in an apparatus container 4 and the apparatus container 4 includes an apparatus container recorded information 5 and the apparatus identifying step 705 is based on the document scanner 20 scanning the apparatus container recorded information 5.

Fourteenth, in one embodiment the detached apparatus 2 is arranged to be disposed or received in an apparatus container 4 and the apparatus container 4 includes an apparatus container recorded information 5 and the apparatus identifying step 705 is based on the sensor 30, 40, 50 sensing the apparatus container recorded information 5.

Fifteenth, in one embodiment the detached apparatus 2 is arranged to be disposed or received in an apparatus container 4 and the apparatus container 4 includes an apparatus container recorded information 5 and the apparatus identifying step 705 is based on both the document scanner 20 scanning and the sensor 30, 40, 50 sensing the apparatus container recorded information 5.

Sixteenth, in one embodiment the detached apparatus 2 is arranged to be disposed or received in an apparatus container 4 and the apparatus container 4 includes an apparatus container shape and the apparatus identifying step 705 is based on the document scanner 20 scanning the apparatus container shape.

Seventeenth, in one embodiment the detached apparatus 2 is arranged to be disposed or received in an apparatus container 4 and the apparatus container 4 includes an apparatus container shape and the apparatus identifying step 705 is based on the sensor 30, 40, 50 sensing the apparatus container shape.

Eighteenth, in one embodiment the detached apparatus 2 is arranged to be disposed or received in an apparatus container 4 and the apparatus container 4 includes an apparatus container shape and the apparatus identifying step 705 is based on both the document scanner 20 scanning and the sensor 30, 40, 50 sensing the apparatus container shape.

Nineteenth, in one embodiment a detached apparatus media 6 is provided and the apparatus identifying step 705 is based on the document scanner 20 scanning the detached apparatus media 6.

Twentieth, in one embodiment a detached apparatus media 6 is provided and the apparatus identifying step 705 is based on the sensor 30, 40, 50 sensing the detached apparatus media 6.

Twenty-first, in one embodiment a detached apparatus media 6 is provided and the apparatus identifying step 705 is based on both the document scanner 20 scanning and the sensor 30, 40, 50 sensing the detached apparatus media 6.

Twenty-second, in one embodiment a detached apparatus media 6 is provided and the detached apparatus media 6 includes an apparatus media recorded information 7 and the apparatus identifying step 705 is based on the document scanner 20 scanning the apparatus media recorded information 7.

Twenty-third, in one embodiment a detached apparatus media 6 is provided and the detached apparatus media 6 includes an apparatus media recorded information 7 and the apparatus identifying step 705 is based on the sensor 30, 40, 50 sensing the apparatus media recorded information 7.

Twenty-fourth, in one embodiment a detached apparatus media 6 is provided and the detached apparatus media 6 includes an apparatus media recorded information 7 and the apparatus identifying step 705 is based on both the document scanner 20 scanning and the sensor 30, 40, 50 sensing the apparatus media recorded information 7.

Twenty-fifth, in one embodiment a detached apparatus media 6 is provided and the detached apparatus media 6 includes an apparatus media shape and the apparatus identifying step 705 is based on the document scanner 20 scanning the apparatus media shape.

Twenty-sixth, in one embodiment a detached apparatus media 6 is provided and the detached apparatus media 6 includes an apparatus media shape and the apparatus identifying step 705 is based on the sensor 30, 40, 50 sensing the apparatus media shape.

Twenty-seventh, in one embodiment a detached apparatus media 6 is provided and the detached apparatus media 6 includes an apparatus media shape and the apparatus identifying step 705 is based on both the document scanner 20 scanning and the sensor 30, 40, 50 sensing the apparatus media shape.

After completing the apparatus identifying step 705, the process 700 goes to step 707, designated “provide signal(s)”.

In the signal providing step 707, the image forming device 100-600 provides one or more signals 81, 82, 83 based on the detached apparatus 2.

Referring to the signal providing step 707, in one embodiment the image forming device 100-600 provides at least a user signal 81.

With continued reference to the signal providing step 707, in one embodiment the image forming device 100-600 provides a user signal 81 based on when the detached apparatus 2 can be attached to or used with the image forming device 100-600.

With further continued reference to the signal providing step 707, in one embodiment the image forming device 100-600 provides a remote service signal 82 based on when it is not possible for the detached apparatus 2 to be attached to the image forming device 100-600.

In one embodiment, for example the remote service signal 82 is used to inform or alert a maintenance or service individual, group, organization, system or entity that maintenance or service is needed by the human user or operator 9.

In another embodiment, for example, the remote service signal 82 is used to inform or alert a maintenance or service individual, group, organization, system or entity that maintenance or service is needed by the image forming device 100-600.

In a further embodiment, for example the remote service signal 82 is used to inform or alert a maintenance or service individual, group, organization, system or entity that maintenance or service is needed by both the human user or operator 9 and the image forming device 100-600.

With still further continued reference to the signal providing step 707, in one embodiment the image forming device 100-600 provides an internal adjusting signal 83 based on the detached apparatus 2.

In one embodiment, for example, the internal adjusting signal 83 is used to adjust the image forming device 100-600 internal image forming process based on the detached apparatus 2.

In another embodiment, for example, the detached apparatus 2 comprises one or more media sheets and the internal adjusting signal 83 is used to adjust the media supply 60 based on one or media sheet characteristics, attributes or parameters such as, for example, a media sheet type, color, weight, thickness, composition, material, dimension or size.

After completing the signal providing step 707, the process 700 goes to step 709, designated “end”, where the process is complete.

Thus, in one embodiment, the present invention uses the existing onboard digital scanner 20 and image processing software 10 of a reprographic machine 100-600 to input scan and process some or all features of a detached apparatus 2 such as, for example, a product, consumable or packaging, in order to identify and authenticate the item. The operator will scan a feature of the detached apparatus 2 or product UPC code, toner/replenisher bottle, glyph graphics from a carton or apparatus container 4 or packaging insert or detached apparatus media 6, colors of a product logo, or other distinctive feature. Software will process the image and detect unique aspects of the image, thus authenticating the item or detached apparatus 2. The software to enable the machine to operate in a specific manner will then use this information. For example, an operator could scan the packaging or detached apparatus media 6 for a toner cartridge to verify that it is correct for that particular machine. Or, the scanning function could recognize that the toner or detached apparatus 2 is not authentic, and disallow use within the machine. The data inputs could allow product tracking and therefore supply chain integrity verification, and other usage information also.

The invention utilizes existing technology in a new way. Digital scanning equipment is common in reprographic machines, as is a CPU and software. Software exists which recognizes glyphs, UPC codes, colors, and other unique identifying images. The invention combines these subsystems to provide a new capability.

This invention has a wide variety of applications. Moreover, the invention's providing information gleaned from a scan of the product or product packaging provides important advantages. Some advantages of the invention are now described.

A first advantage of the invention is that it achieves an improvement in output quality or machine performance. Confirming that the correct toner is used in a machine is important. This invention would negate the need to incorporate physical changes to cartridges to provide mechanical or electrical interlocks that prevent cartridge interchange between products. As another example, if the packaging on a ream of paper is scanned before being loaded into a paper tray, the machine could make appropriate adjustments for that paper stock, color, and gloss. Likewise, this information color, stock, and gloss paper located in a specific tray could be available to a remote user for selection from a list of paper trays. This information could also be used to tell the operator which paper tray is best to load that material into. This mechanism for identifying the product would be easier, more convenient, and less prone to error.

A second advantage of the invention is that it provides positive confirmation of the authenticity of a product. Informing an operator that the consumable is not authentic could prevent output quality issues or machine downtime. Information regarding a black-market product could be sent to appropriate personnel for action for example, through telephone communication linked to the machine or stored on the machine's memory for later retrieval. Or, the information could be used to confirm that the consumable is correct for that specific machine.

A third advantage of the invention is that the resulting data collected from a scan of a product or packaging can be used to track the final point of use of a consumable product. This information has many benefits to supply chain management, quality control, etc. For example, if this invention were implemented on a machine, it would be possible to track a lot or batch of toner to the field. It is currently possible to know the quantity of toner released from a specific batch and mark those bottles with some unique identifier. If an operator was forced to utilize the concept in this invention to authenticate the toner bottle prior to insertion, this data could be transmitted back to a corporate office. With this information, it could easily be calculated how many bottles of toner from that specific batch remain in the field.

A fourth advantage of this invention is that it provides a lower cost alternative than RFID because the features and system hardware in large part exists in the xerographic function of the machine. No additional detection devices and associated hardware that are needed for RFID implementation are required. Also, the unit cost of apparatus containers is lower since an RFID tag is not needed currently around $0.90/apparatus container.

A fifth advantage of this invention is that its intrinsic onboard scanning capability of the reprographic machine can be used to confirm an operator's identity. For example, the machine could scan the operator's palms, fingers, or retina. This information could be used to prevent any unauthorized personnel from using the machine.

Moreover, there will soon be a need to distinguish between cartridges of LEX toner and EA toner for the Tigris platform machines. Current Nuvera machines use LEX toner and soon-to-be-released Dneiper machines will use EA toner. The two toner-cartridges for these machines are essentially the same, except for a different colored fill cap. There are adverse consequences associated with inserting the wrong toner cartridge into a machine. In order to resolve this, we might use this invention to authenticate which type of toner is in the cartridge by means of a UPC code, product logo, color of the cap on the toner cartridge, etc. This information would then be used to allow or prevent use of the cartridge in the machine.

Thus, there is described the first aspect of the invention, namely, an image forming device 100 including a document scanner 20 to scan 21 a document 1, the image forming device 100 arranged to identify (by step 705) a detached apparatus 2 based on a detecting step 703 by the document scanner 20.

In a first variation of this first aspect, the detecting step 703 includes the document scanner 20 scanning 22 the detached apparatus 2.

In a second variation of this first aspect, the detached apparatus 2 includes an apparatus recorded information 3 and the detecting step 703 includes the document scanner 20 scanning 23 the apparatus recorded information 3.

In a third variation of this first aspect, the detached apparatus 2 is arranged to be disposed or received in an apparatus container 4 and the detecting step 703 includes the document scanner 20 scanning 24 the apparatus container 4.

In a fourth variation of this first aspect, the detached apparatus 2 is arranged to be disposed or received in an apparatus container 4 and the apparatus container 4 includes an apparatus container recorded information 5 and the detecting step 703 includes the document scanner 20 scanning 25 the apparatus container recorded information 5.

In a fifth variation of this first aspect, the detecting step 703 includes the document scanner 20 scanning 26 an included detached apparatus media 6.

In a sixth variation of this first aspect, the detecting step 703 includes the document scanner 20 scanning 27 an apparatus media recorded information 7 that is comprised in an included detached apparatus media 6.

In a seventh variation of this first aspect, image forming device 100 is arranged to provide (by step 707) one or more signals based on the detached apparatus 2, the one or more signals including at least a user signal 81.

In an eighth variation of this first aspect, the user signal 81 is based on when the detached apparatus 2 can be attached to or used with the image forming device 1 00.

In a ninth variation of this first aspect, the document scanner 20 is arranged to detect step 703 both human-visible and human-non-visible signals 21-27.

Also, there is described the second aspect of the invention, namely, an image forming device 200 including a document scanner 20, the image forming device 200 arranged to identify (by step 705) a detached apparatus 2 based on a detecting step 703 by an included sensor 30, 40, 50.

In a first variation of this second aspect, the detecting step 703 includes the sensor 30, 40, 50 sensing the detached apparatus 2.

In a second variation of this second aspect, the detached apparatus 2 includes an apparatus recorded information 3 and the detecting step 703 includes the sensor 30, 40, 50 sensing the apparatus recorded information 3.

In a third variation of this second aspect, the detached apparatus 2 is arranged to be disposed or received in an apparatus container 4 and the detecting step 703 includes the sensor 30, 40, 50 sensing the apparatus container 4.

In a fourth variation of this second aspect, the detached apparatus 2 is arranged to be disposed or received in an apparatus container 4 and the apparatus container 4 includes an apparatus container recorded information 5 and the detecting step 703 includes the sensor 30, 40, 50 sensing the apparatus container recorded information 5.

In a fifth variation of this second aspect, the detecting step 703 includes the sensor 30, 40, 50 sensing an included detached apparatus media 6.

In a sixth variation of this second aspect, the detecting step 703 includes the sensor 30, 40, 50 sensing an apparatus media recorded information 7 that is comprised in an included detached apparatus media 6.

In a seventh variation of this second aspect, the image forming device 200 is arranged to provide (by step 707) one or more signals based on the detached apparatus 2, the one or more signals including at least a user signal 81 based on when the detached apparatus 2 can be attached to or used with the image forming device 200.

In an eighth variation of this second aspect, the document scanner 20 is arranged to scan a document 1 based on a scanning signal 21 passing through an included platen 201, and the detecting step 703 includes the sensor 30, 40, 50 sensing signals 32-37, 42-47, 52-57 that pass through the same platen 201.

In a ninth variation of this second aspect, the sensor 30 is arranged to sense human-visible signals 32-37.

In a tenth variation of this second aspect, the sensor 40 is arranged to sense human-non-visible signals 42-47.

In an eleventh variation of this second aspect, the sensor 50 is arranged to sense signals 52-57 comprising both human-visible and human-non-visible signals.

In a twelfth variation of this second aspect, the sensor 30, 40, 50 is arranged to sense human-visible signals 32-37; or human-non-visible signals 42-47; or signals 52-57 comprising both human-visible and human-non-visible signals.

Also, there is described the third aspect of the invention, namely, an image forming device 300 including a document scanner 20 to scan a document 1 based on a document scanning signal 21, the image forming device 300 arranged to identify (by step 705) a detached apparatus 2 based on a detecting step 703 by both the document scanner 20 and an included sensor 30, 40, 50.

In a first variation of this third aspect, the detecting step 703 includes the document scanner 20 scanning 22 the detached apparatus 2.

In a second variation of this third aspect, the detecting step 703 includes the sensor 30, 40, 50 sensing the detached apparatus 2.

In a third variation of this third aspect, the detecting step 703 includes the document scanner 20 scanning and the sensor 30, 40, 50 sensing the detached apparatus 2.

In a fourth variation of this third aspect, the detecting step 703 includes the document scanner 20 scanning 22 the detached apparatus 2; or the sensor 30, 40, 50 sensing the detached apparatus 2; or both the document scanner 20 scanning and the sensor 30, 40, 50 sensing the detached apparatus 2.

In a fifth variation of this third aspect, the detached apparatus 2 includes an apparatus recorded information 3 and the detecting step 703 includes the document scanner 20 scanning 23 the apparatus recorded information 3.

In a sixth variation of this third aspect, the detached apparatus 2 includes an apparatus recorded information 3 and the detecting step 703 includes the sensor 30, 40, 50 sensing the apparatus recorded information 3.

In a seventh variation of this third aspect, the detached apparatus 2 includes an apparatus recorded information 3 and the detecting step 703 includes the document scanner 20 scanning and the sensor 30, 40, 50 sensing the apparatus recorded information 3.

In an eighth variation of this third aspect, the detached apparatus 2 includes an apparatus recorded information 3 and the detecting step 703 includes the document scanner 20 scanning 23 the apparatus recorded information 3; or the sensor 30, 40, 50 sensing the apparatus recorded information 3; or the document scanner 20 scanning and the sensor 30, 40, 50 sensing the apparatus recorded information 3.

In a ninth variation of this third aspect, the detached apparatus 2 is arranged to be disposed or received in an apparatus container 4 and the detecting step 703 includes the document scanner 20 scanning 24 the apparatus container 4.

In a tenth variation of this third aspect, the detached apparatus 2 is arranged to be disposed or received in an apparatus container 4 and the detecting step 703 includes the sensor 30, 40, 50 sensing the apparatus container 4.

In an eleventh variation of this third aspect, the detached apparatus 2 is arranged to be disposed or received in an apparatus container 4 and the detecting step 703 includes the document scanner 20 scanning and the sensor 30, 40, 50 sensing the apparatus container 4.

In a twelfth variation of this third aspect, the detached apparatus 2 is arranged to be disposed or received in an apparatus container 4 and the detecting step 703 includes the document scanner 20 scanning 24 the apparatus container 4; or the sensor 30, 40, 50 sensing the apparatus container 4; or both the document scanner 20 scanning and the sensor 30, 40, 50 sensing the apparatus container 4.

In a thirteenth variation of this third aspect, the detached apparatus 2 is arranged to be disposed or received in an apparatus container 4 and the apparatus container 4 includes an apparatus container recorded information 5 and the detecting step 703 includes the document scanner 20 scanning 25 the apparatus container recorded information 5.

In a fourteenth variation of this third aspect, the detached apparatus 2 is arranged to be disposed or received in an apparatus container 4 and the apparatus container 4 includes an apparatus container recorded information 5 and the detecting step 703 includes the sensor 30, 40, 50 sensing the apparatus container recorded information 5.

In a fifteenth variation of this third aspect, the detached apparatus 2 is arranged to be disposed or received in an apparatus container 4 and the apparatus container 4 includes an apparatus container recorded information 5 and the detecting step 703 includes the document scanner 20 scanning and the sensor 30, 40, 50 sensing the apparatus container recorded information 5.

In a sixteenth variation of this third aspect, the detached apparatus 2 is arranged to be disposed or received in an apparatus container 4 and the apparatus container 4 includes an apparatus container recorded information 5 and the detecting step 703 includes the document scanner 20 scanning 25 the apparatus container recorded information 5; or the sensor 30, 40, 50 sensing the apparatus container recorded information 5; or both the document scanner 20 scanning and the sensor 30, 40, 50 sensing the apparatus container recorded information 5.

In a seventeenth variation of this third aspect, the detecting step 703 includes the document scanner 20 scanning 26 an included detached apparatus media 6.

In an eighteenth variation of this third aspect, the detecting step 703 includes the sensor 30, 40, 50 sensing an included detached apparatus media 6.

In a nineteenth variation of this third aspect, the detecting step 703 includes the document scanner 20 scanning and the sensor 30, 40, 50 sensing an included detached apparatus media 6.

In a twentieth variation of this third aspect, the detecting step 703 includes the document scanner 20 scanning 26 an included detached apparatus media 6; or the sensor 30, 40, 50 sensing an included detached apparatus media 6; or both the document scanner 20 scanning and the sensor 30, 40, 50 sensing an included detached apparatus media 6.

In a twenty-first variation of this third aspect, the detecting step 703 includes the document scanner 20 scanning 27 an apparatus media recorded information 7 that is comprised in an included detached apparatus media 6.

In a twenty-second variation of this third aspect, the detecting step 703 includes the sensor 30, 40, 50 sensing an apparatus media recorded information 7 that is comprised in an included detached apparatus media 6.

In a twenty-third variation of this third aspect, the detecting step 703 includes the document scanner 20 scanning and the sensor 30, 40, 50 sensing an apparatus media recorded information 7 that is comprised in an included detached apparatus media 6.

In a twenty-fourth variation of this third aspect, the detecting step 703 includes the document scanner 20 scanning 27 an apparatus media recorded information 7 that is comprised in an included detached apparatus media 6; or the sensor 30, 40, 50 sensing an apparatus media recorded information 7 that is comprised in an included detached apparatus media 6; or both the document scanner 20 scanning and the sensor 30, 40, 50 sensing an apparatus media recorded information 7 that is comprised in an included detached apparatus media 6.

In a twenty-fifth variation of this third aspect, the image forming device 300 is arranged to provide (by step 707) one or more signals based on the detached apparatus 2, the one or more signals including at least a user signal 81 based on when the detached apparatus 2 can be attached to or used with the image forming device 300.

In a twenty-sixth variation of this third aspect, the detecting step 703 includes the document scanner 20 detecting signals 21-27 that pass through an included platen 301 and the sensor 30, 40, 50 sensing signals 32-37, 42-47, 52-57 that pass through the same platen 301.

In a twenty-seventh variation of this third aspect, the sensor 30 is arranged to sense human-visible signals 32-37.

In a twenty-eighth variation of this third aspect, the sensor 40 is arranged to sense human-non-visible signals 42-47.

In a twenty-ninth variation of this third aspect, the sensor 50 is arranged to sense signals 52-57 comprising both human-visible and human-non-visible signals.

In a thirtieth variation of this third aspect, the sensor 30, 40, 50 is arranged to sense human-visible signals 32-37; or human-non-visible signals 42-47; or signals 52-57 comprising both human-visible and human-non-visible signals.

Also, there is described the fourth aspect of the invention, namely, an image forming device 400 arranged to scan a document 1 based on an included document scanner 20 detecting a scanning signal 21 passing through an included scanning platen 401, the image forming device 400 arranged to identify (by step 705) a detached apparatus 2 based on a detecting step 703 comprising an included sensor 30, 40, 50 sensing signals 32-37, 42-47, 52-57 that do not pass through the document scanning platen 401.

In a first variation of this fourth aspect, the detecting step 703 includes the sensor 30, 40, 50 sensing the detached apparatus 2.

In a second variation of this fourth aspect, the detached apparatus 2 includes an apparatus recorded information 3 and the detecting step 703 includes the sensor 30, 40, 50 sensing the apparatus recorded information 3.

In a third variation of this fourth aspect, the detached apparatus 2 is arranged to be disposed or received in an apparatus container 4 and the detecting step 703 includes the sensor 30, 40, 50 sensing the apparatus container 4.

In a fourth variation of this fourth aspect, the detached apparatus 2 is arranged to be disposed or received in an apparatus container 4 and the apparatus container 4 includes an apparatus container recorded information 5 and the detecting step 703 includes the sensor 30, 40, 50 sensing the apparatus container recorded information 5.

In a fifth variation of this fourth aspect, the detecting step 703 includes the sensor 30, 40, 50 sensing an included detached apparatus media 6.

In a sixth variation of this fourth aspect, the detecting step 703 includes the sensor 30, 40, 50 sensing an apparatus media recorded information 7 that is comprised in an included detached apparatus media 6.

In a seventh variation of this fourth aspect, the image forming device 400 is arranged to provide (by step 707) one or more signals based on the detached apparatus 2, the one or more signals including at least a user signal 81 based on when the detached apparatus 2 can be attached to or used with the image forming device 400.

In an eighth variation of this fourth aspect, the sensor 30, 40, 50 senses signals 32-37, 42-47, 52-57 that pass through an included sensing platen 402.

In a ninth variation of this fourth aspect, the sensor 30 is arranged to sense human-visible signals 32-37.

In a tenth variation of this fourth aspect, the sensor 40 is arranged to sense human-non-visible signals 42-47.

In an eleventh variation of this fourth aspect, the sensor 50 is arranged to sense signals 52-57 comprising both human-visible and human-non-visible signals.

In a twelfth variation of this fourth aspect, the sensor 30, 40, 50 is arranged to sense human-visible signals 32-37; or human-non-visible signals 42-47; or signals 52-57 comprising both human-visible and human-non-visible signals.

Also, there is described the fifth aspect of the invention, namely, an image forming device 500 arranged to identify (by step 705) a detached apparatus 2 based on a detecting step 703 comprising both an included document scanner 20 detecting signals 22-27 that pass through an included scanning platen 501 and an included sensor 30, 40, 50 sensing signals 32-37, 42-47, 52-57 that do not pass through the scanning platen 501.

In a first variation of this fifth aspect, the detecting step 703 includes the document scanner 20 scanning 22 the detached apparatus 2.

In a second variation of this fifth aspect, the detecting step 703 includes the sensor 30, 40, 50 sensing the detached apparatus 2.

In a third variation of this fifth aspect, the detecting step 703 includes the document scanner 20 scanning and the sensor 30, 40, 50 sensing the detached apparatus 2.

In a fourth variation of this fifth aspect, the detecting step 703 includes the document scanner 20 scanning 22 the detached apparatus 2; or the sensor 30, 40, 50 sensing the detached apparatus 2; or both the document scanner 20 scanning and the sensor 30, 40, 50 sensing the detached apparatus 2.

In a fifth variation of this fifth aspect, the detached apparatus 2 includes an apparatus recorded information 3 and the detecting step 703 includes the document scanner 20 scanning 23 the apparatus recorded information 3.

In a sixth variation of this fifth aspect, the detached apparatus 2 includes an apparatus recorded information 3 and the detecting step 703 includes the sensor 30, 40, 50 sensing the apparatus recorded information 3.

In a seventh variation of this fifth aspect, the detached apparatus 2 includes an apparatus recorded information 3 and the detecting step 703 includes the document scanner 20 scanning and the sensor 30, 40, 50 sensing the apparatus recorded information 3.

In an eighth variation of this fifth aspect, the detached apparatus 2 includes an apparatus recorded information 3 and the detecting step 703 includes the document scanner 20 scanning 23 the apparatus recorded information 3; or the sensor 30, 40, 50 sensing the apparatus recorded information 3; or both the document scanner 20 scanning and the sensor 30, 40, 50 sensing the apparatus recorded information 3.

In a ninth variation of this fifth aspect, the detached apparatus 2 is arranged to be disposed in a corresponding apparatus container 4 and the detecting step 703 includes the document scanner 20 scanning 24 the apparatus container 4.

In a tenth variation of this fifth aspect, the detached apparatus 2 is arranged to be disposed in a corresponding apparatus container 4 and the detecting step 703 includes the sensor 30, 40, 50 sensing the apparatus container 4.

In an eleventh variation of this fifth aspect, the detached apparatus 2 is arranged to be disposed in a corresponding apparatus container 4 and the detecting step 703 includes the document scanner 20 scanning and the sensor 30, 40, 50 sensing the apparatus container 4.

In a twelfth variation of this fifth aspect, the detached apparatus 2 is arranged to be disposed in a corresponding apparatus container 4 and the detecting step 703 includes the document scanner 20 scanning 24 the apparatus container 4; or the sensor 30, 40, 50 sensing the apparatus container 4; or both the document scanner 20 scanning and the sensor 30, 40, 50 sensing the apparatus container 4.

In a thirteenth variation of this fifth aspect, the detached apparatus 2 is arranged to be disposed in a corresponding apparatus container 4 and the apparatus container 4 includes an apparatus container recorded information 5 and the detecting step 703 includes the document scanner 20 scanning 25 the apparatus container recorded information 5.

In a fourteenth variation of this fifth aspect, the detached apparatus 2 is arranged to be disposed in a corresponding apparatus container 4 and the apparatus container 4 includes an apparatus container recorded information 5 and the detecting step 703 includes the sensor 30, 40, 50 sensing the apparatus container recorded information 5.

In a fifteenth variation of this fifth aspect, the detached apparatus 2 is arranged to be disposed in a corresponding apparatus container 4 and the apparatus container 4 includes an apparatus container recorded information 5 and the detecting step 703 includes the document scanner 20 scanning and the sensor 30, 40, 50 sensing the apparatus container recorded information 5.

In a sixteenth variation of this fifth aspect, the detached apparatus 2 is arranged to be disposed in a corresponding apparatus container 4 and the apparatus container 4 includes an apparatus container recorded information 5 and the detecting step 703 includes the document scanner 20 scanning 25 the apparatus container recorded information 5; or the sensor 30, 40, 50 sensing the apparatus container recorded information 5; or both the document scanner 20 scanning and the sensor 30, 40, 50 sensing the apparatus container recorded information 5.

In a seventeenth variation of this fifth aspect, the detecting step 703 includes the document scanner 20 scanning 26 an included detached apparatus media 6.

In an eighteenth variation of this fifth aspect, the detecting step 703 includes the sensor 30, 40, 50 sensing an included detached apparatus media 6.

In a nineteenth variation of this fifth aspect, the detecting step 703 includes the document scanner 20 scanning and the sensor 30, 40, 50 sensing an included detached apparatus media 6.

In a twentieth variation of this fifth aspect, the detecting step 703 includes the document scanner 20 scanning 26 an included detached apparatus media 6; or the sensor 30, 40, 50 sensing an included detached apparatus media 6; or both the document scanner 20 scanning and the sensor 30, 40, 50 sensing an included detached apparatus media 6.

In a twenty-first variation of this fifth aspect, the detecting step 703 includes the document scanner 20 scanning 27 an apparatus media recorded information 7 that is comprised in an included detached apparatus media 6.

In a twenty-second variation of this fifth aspect, the detecting step 703 includes the sensor 30, 40, 50 sensing an apparatus media recorded information 7 that is comprised in an included detached apparatus media 6.

In a twenty-third variation of this fifth aspect, the detecting step 703 includes the document scanner 20 scanning and the sensor 30, 40, 50 sensing an apparatus media recorded information 7 that is comprised in an included detached apparatus media 6.

In a twenty-fourth variation of this fifth aspect, the detecting step 703 includes the document scanner 20 scanning 27 an apparatus media recorded information 7 that is comprised in an included detached apparatus media 6; or the sensor 30, 40, 50 sensing an apparatus media recorded information 7 that is comprised in an included detached apparatus media 6; or both the document scanner 20 scanning and the sensor 30, 40, 50 sensing an apparatus media recorded information 7 that is comprised in an included detached apparatus media 6.

In a twenty-fifth variation of this fifth aspect, the image forming device 500 is arranged to provide (by step 707) one or more signals based on the detached apparatus 2, the one or more signals including at least a user signal 81 based on when the detached apparatus 2 can be attached to or used with the image forming device 500.

In a twenty-sixth variation of this fifth aspect, the sensor 30, 40, 50 senses signals 32-37, 42-47, 52-57 that pass through an included sensing platen 502.

In a twenty-seventh variation of this fifth aspect, the sensor 30 is arranged to sense human-visible signals 32-37.

In a twenty-eighth variation of this fifth aspect, the sensor 40 is arranged to sense human-non-visible signals 42-47.

In a twenty-ninth variation of this fifth aspect, the sensor 50 is arranged to sense signals 52-57 comprising both human-visible and human-non-visible signals.

In a thirtieth variation of this fifth aspect, the sensor 30, 40, 50 is arranged to sense human-visible signals 32-37; or human-non-visible signals 42-47; or signals 52-57 comprising both human-visible and human-non-visible signals.

Also, there is described the sixth aspect of the invention, namely, an image forming device 600 comprising a marking device 600 arranged to identify (by step 705) a detached apparatus 2 based on a detecting step 703 comprising an included sensor 30, 40, 50 sensing signals 32-37, 42-47, 52-57.

In a first variation of this sixth aspect, the detecting step 703 includes the sensor 30, 40, 50 sensing the detached apparatus 2.

In a second variation of this sixth aspect, the detached apparatus 2 includes an apparatus recorded information 3 and the detecting step 703 includes the sensor 30, 40, 50 sensing the apparatus recorded information 3.

In a third variation of this sixth aspect, the detached apparatus 2 is arranged to be disposed or received in an apparatus container 4 and the detecting step 703 includes the sensor 30, 40, 50 sensing the apparatus container 4.

In a fourth variation of this sixth aspect, the detached apparatus 2 is arranged to be disposed or received in an apparatus container 4 and the apparatus container 4 includes an apparatus container recorded information 5 and the detecting step 703 includes the sensor 30, 40, 50 sensing the apparatus container recorded information 5.

In a fifth variation of this sixth aspect, the detecting step 703 includes the sensor 30, 40, 50 sensing an included detached apparatus media 6.

In a sixth variation of this sixth aspect, the detecting step 703 includes the sensor 30, 40, 50 sensing an apparatus media recorded information 7 that is comprised in an included detached apparatus media 6.

In a seventh variation of this sixth aspect, the marking device 600 is arranged to provide (by step 707) one or more signals based on the detached apparatus 2, the one or more signals including at least a user signal 81 based on when the detached apparatus 2 can be attached to or used with the marking device 600.

In an eighth variation of this sixth aspect, the marking device 600 is devoid of a document scanner 20.

In a ninth variation of this sixth aspect, the sensor 30 is arranged to sense human-visible signals 32-37.

In a tenth variation of this sixth aspect, the sensor 40 is arranged to sense human-non-visible signals 42-47.

In an eleventh variation of this sixth aspect, the sensor 50 is arranged to sense signals 52-57 comprising both human-visible and human-non-visible signals.

In a twelfth variation of this sixth aspect, the sensor 30, 40, 50 is arranged to sense human-visible signals 32-37; or human-non-visible signals 42-47; or signals 52-57 comprising both human-visible and human-non-visible signals.

Also, there is described the seventh aspect of the invention, namely, an image forming device 100-600 arranged to identify (by step 705) a detached apparatus 2 and to provide (by step 707) one or more signals based on the detached apparatus 2, the one or more signals includes at least a user signal 81 based on when the detached apparatus 2 can be attached to or used with the image forming device.

In a first variation of this seventh aspect, the image forming device 100 includes a document scanner 20 and arranged to identify (by step 705) the detached apparatus 2 based on a detecting step 703 by the document scanner 20.

In a second variation of this seventh aspect, the image forming device 200 includes a document scanner 20 and a sensor 30, 40, 50 and arranged to identify (by step 705) the detached apparatus 2 based on a detecting step 703 by the sensor 30, 40, 50.

In a third variation of this seventh aspect, the image forming device 300 includes a document scanner 20 and a sensor 30, 40, 50 and arranged to identify (by step 705) the detached apparatus 2 based on a detecting step 703 by both the document scanner 20 and the sensor 30, 40, 50.

In a fourth variation of this seventh aspect, the image forming device 400 includes a document scanner 20 to scan a document 1 based on a scanning signal 21 that passes through an included scanning platen 401 and further includes a sensor 30, 40, 50 and arranged to identify (by step 705) the detached apparatus 2 based on the sensor 30, 40, 50 detecting (by step 703) signals 32-37, 42-47, 52-57 that do not pass through the scanning platen 401.

In a fifth variation of this seventh aspect, the image forming device 500 includes a document scanner 20 and a sensor 30, 40, 50 and arranged to identify (by step 705) the detached apparatus 2 based on a detecting step 703 by both the document scanner 20 detecting signals 22-27 that pass through an included scanning platen 501 and the sensor 30, 40, 50 sensing signals 32-37, 42-47, 52-57 that do not pass through the scanning platen 501.

In a sixth variation of this seventh aspect, image forming device comprises a marking device 600 that is devoid of a document scanner 20 and that includes a sensor 30, 40, 50 and arranged to identify (by step 705) the detached apparatus 2 based on a detecting step 703 by the sensor 30, 40, 50.

In an seventh variation of this seventh aspect, the detached apparatus 2 comprises an apparatus shape and the image forming device 100-600 is arranged to identify (by step 705) the detached apparatus 2 based on the apparatus shape.

In an eighth variation of this seventh aspect, the detached apparatus 2 is arranged to be disposed or received in an apparatus container 4 that comprises an apparatus container shape and the image forming device 100-600 is arranged to identify (by step 705) the detached apparatus 2 based on the apparatus container shape.

In a ninth variation of this seventh aspect, the image forming device 100-600 is arranged to identify (by step 705) the detached apparatus 2 based on an apparatus media shape that is comprised in an included detached apparatus media 6.

In an tenth variation of this seventh aspect, the image forming device 100-600 is arranged to identify (by step 705) the detached apparatus 2 based on an apparatus shape that is comprised in the detached apparatus 2; or based on an apparatus container shape that is comprised in an apparatus container 4 and the detached apparatus 2 is arranged to be disposed or received in the apparatus container 4; or based on an apparatus media shape that is comprised in an included detached apparatus media 6.

In an eleventh variation of this seventh aspect, the detached apparatus 2 comprises one or more media sheets and where the image forming device 100-600 comprises a media supply means 60 and is arranged to provide (by step 707) a user signal 81 based on when the one or more media sheets can be disposed in the media supply means 60.

In a twelfth variation of this seventh aspect, the image forming device 100-600 is further arranged to provide (by step 707) a remote service signal 82 based on when it is not possible for the detached apparatus 2 to be attached to the image forming device 100-600.

In a thirteenth variation of this seventh aspect, the image forming device 100-600 is further arranged to provide (by step 707) an internal adjusting signal 83 that is based on the detached apparatus 2.

Also, there is described the eighth aspect of the invention, namely, a method 700 to identify a detached apparatus 2 in an image forming device 100, the image forming device 100 including a document scanner 20 to scan 21 a document 1, the method comprising a detecting step 703 by the document scanner 20.

Also, there is described the ninth aspect of the invention, namely, a method 700 to identify a detached apparatus 2 in an image forming device 200, the image forming device 200 including a document scanner 20, the method comprising a detecting step 703 by an included sensor 30, 40, 50.

Also, there is described the tenth aspect of the invention, namely, a method 700 to identify a detached apparatus 2 in an image forming device 300, the image forming device 300 including a document scanner 20 to scan a document 1, the method comprising a detecting step 703 by both the document scanner 20 and an included sensor 30, 40, 50.

Also, there is described the eleventh aspect of the invention, namely, a method 700 to identify a detached apparatus 2 in an image forming device 400, the image forming device 400 arranged to scan a document 1 based on an included document scanner 20 detecting a scanning signal 21 passing through an included scanning platen 401, the method including a detecting step 703 comprising an included sensor 30, 40, 50 sensing signals 32-37, 42-47, 52-57 that do not pass through the scanning platen 401.

Also, there is described the twelfth aspect of the invention, namely, a method 700 to identify a detached apparatus 2 in an image forming device 500, the image forming device 500 including a scanning platen 501, the method including a detecting step 703 comprising both an included document scanner 20 detecting signals 22-27 that pass through the scanning platen 501 and an included sensor 30, 40, 50 sensing signals 32-37, 42-47, 52-57 that do not pass through the scanning platen 501.

Also, there is described the thirteenth aspect of the invention, namely, a method 700 to identify a detached apparatus 2 in a marking device 600, the marking device 600 including a sensor 30, 40, 50, the method comprising a detecting step 703 comprising the sensor 30, 40, 50 sensing signals 32-37, 42-47, 52-57.

Also, there is described the fourteenth aspect of the invention, namely, a method 700 for an image forming device 100-600 to identify (by step 705) a detached apparatus 2 and to provide (by step 707) one or more signals based on the detached apparatus 2, the one or more signals including at least a user signal 81 based on when the detached apparatus 2 can be attached to or used with the image forming device.

In a first variation of this fourteenth aspect, the image forming device 100 including a document scanner 20 and where the identifying (step 705) is based on a detecting step 703 by the document scanner 20.

In a second variation of this fourteenth aspect, the image forming device 200 including a document scanner 20 and a sensor 30, 40, 50 and where the identifying (step 705) is based on a detecting step 703 by the sensor 30, 40, 50.

In a third variation of this fourteenth aspect, the image forming device 300 including a document scanner 20 and a sensor 30, 40, 50 and where the identifying (step 705) is based on a detecting step 703 by both the document scanner 20 and the sensor 30, 40, 50.

In a fourth variation of this fourteenth aspect, the image forming device 400 including a document scanner 20 to scan a document 1 based on a scanning signal 21 that passes through an included scanning platen 401 and further including a sensor 30, 40, 50 and where the identifying (step 705) is based on the sensor 30, 40, 50 detecting (by step 703) signals 32-37, 42-47, 52-57 that do not pass through the scanning platen 401.

In a fifth variation of this fourteenth aspect, the image forming device 500 including a document scanner 20 and a sensor 30, 40, 50 and where the identifying (step 705) is based on a detecting step 703 by both the document scanner 20 detecting signals 22-27 that pass through an included scanning platen 501 and the sensor 30, 40, 50 sensing signals 32-37, 42-47, 52-57 that do not pass through the scanning platen 501.

In a sixth variation of this fourteenth aspect, the image forming device comprising a marking device 600 that is devoid of a document scanner 20 and that includes a sensor 30, 40, 50 and where the identifying (step 705) is based on a detecting step 703 by the sensor 30, 40, 50.

In a seventh variation of this fourteenth aspect, the detached apparatus 2 includes an apparatus shape and the identifying (step 705) is based on the apparatus shape; or where the detached apparatus 2 is arranged to be disposed or received in an apparatus container 4 and the apparatus container 4 includes an apparatus container shape and the identifying (step 705) is based on the apparatus container shape; or where the identifying (step 705) is based on an apparatus media shape that is comprised in an included detached apparatus media 6.

In an eighth variation of this fourteenth aspect, the image forming device comprises a media supply means 60 and the detached apparatus 2 comprises one or more media sheets and the method includes providing (by step 707) a user signal 81 based on when the one or more media sheets can be disposed in the media supply means 60.

In a ninth variation of this fourteenth aspect, the image forming device 100-600 is further arranged to provide (by step 707) a remote service signal 82 based on when it is not possible for the detached apparatus 2 to be attached to the image forming device.

In a tenth variation of this fourteenth aspect, the image forming device 100-600 is further arranged to provide (by step 707) an internal adjusting signal 83 that is based on the detached apparatus 2.

Referring generally to all aspects of the invention including without limitation the fourteen 14 aspects described herein, the following three (3) sentences apply:

First, in various embodiments, the detached apparatus 2 depicted in FIGS. 1-6 comprises any of the following: ink cartridge; solid ink stick; toner casing; toner cartridge; toner bottle; toner apparatus container; photosensitive cartridge; photosensitive drum; photosensitive belt; charging unit; laser irradiation unit; developing cartridge; transfer unit; fixing unit; cleaning unit; one or more media sheets; replacement part; attachable part; or other consumable items that can be attached to or used with the image forming device 100-600 of FIGS. 1-6.

Second, in various embodiments, the apparatus container 4 depicted in FIGS. 1-6 comprises any of the following: shipping apparatus container for the detached apparatus 2; shipping box or carton for the detached apparatus 2; shipping packaging for the detached apparatus 2; dispenser for the detached apparatus 2; cartridge for the detached apparatus 2; replenishing bottle for the detached apparatus 2; dispensing bottle for the detached apparatus 2; or other vessel for the detached apparatus 2.

Third, in various embodiments, the detached apparatus media 6 depicted in FIGS. 1-6 comprises any of the following: packaging insert for the detached apparatus 2; product literature for the detached apparatus 2; shipping literature for the detached apparatus 2; user's guide, manual or instructions for the detached apparatus 2; installation guide, manual or instructions for the detached apparatus 2; maintenance guide, manual or instructions for the detached apparatus 2; warranty media for the detached apparatus 2; service media for the detached apparatus 2; or other media based on the detached apparatus 2.

The table below lists the drawing element reference numbers together with their corresponding written description:

| No.: | Description: |
|---|---|
| 1 | document |
| 2 | apparatus |
| 3 | apparatus recorded information |
| 4 | apparatus container |
| 5 | apparatus container recorded information |
| 6 | detached apparatus media |
| 7 | apparatus media recorded information |
| 9 | human user or operator |
| 10 | process 700 and means for performing the same |
| 11 | space or area |
| 20 | document scanner |
| 21 | document scanning signal |
| 22 | apparatus scanning signal |
| 23 | apparatus recorded information scanning signal |
| 24 | apparatus container scanning signal |
| 25 | apparatus container recorded information scanning signal |
| 26 | detached apparatus media scanning signal |
| 27 | apparatus media recorded information scanning signal |
| 28 | document scanner output signal |
| 30 | human-visible-signal sensor |
| 32 | apparatus human-visible sensing signal |
| 33 | apparatus recorded information human-visible sensing signal |
| 34 | apparatus container human-visible sensing signal |
| 35 | apparatus container recorded information human-visible sensing signal |
| 36 | detached apparatus media human-visible sensing signal |
| 37 | apparatus media recorded information human-visible sensing signal |
| 38 | human-visible-signal sensor output signal |
| 40 | human-non-visible-signal sensor |
| 42 | apparatus human-non-visible sensing signal |
| 43 | apparatus recorded information human-non-visible sensing signal |
| 44 | apparatus container human-non-visible sensing signal |
| 45 | apparatus container recorded information human-non-visible sensing signal |
| 46 | detached apparatus media human-non-visible sensing signal |
| 47 | apparatus media recorded information human-non-visible sensing signal |
| 48 | human-non-visible-signal sensor output signal |
| 50 | human-visible-and-non-visible signal sensor |
| 52 | apparatus human-visible-and-non-visible sensing signal |
| 53 | apparatus recorded information human-visible-and-non-visible sensing signal |
| 54 | apparatus container human-visible-and-non-visible sensing signal |
| 55 | apparatus container recorded information human-visible-and-non-visible sensing |
| | signal |
| 56 | detached apparatus media human-visible-and-non-visible sensing signal |
| 57 | apparatus media recorded information human-visible-and-non-visible |
| | sensing signal |
| 58 | human-visible-and-non-visible signal sensor output signal |
| 60 | media supply |
| 61 | media supply signal |
| 81 | user signal |
| 82 | signal |
| 83 | internal signal |
| 100–600 | image forming device |
| 101 | platen |
| 201 | platen |
| 301 | platen |
| 401 | platen |
| 402 | platen optional |
| 501 | platen |
| 502 | platen optional |
| 602 | platen optional |
| 700 | method or process |
| 701 | start |
| 703 | detecting |
| 705 | identify apparatus |
| 707 | provide signals |
| 709 | end |

While particular embodiments have been described hereinabove, alternatives, modifications, variations, improvements and substantial equivalents that are or may be presently unforeseen may arise to applicants or others skilled in the art. Accordingly, the appended claims as filed and as they may be amended are intended to embrace all such alternatives, modifications, variations, improvements and substantial equivalents.

1. A method for an image forming device to identify a detached apparatus, the image forming device including a document scanner to scan a document, the method comprising a detecting by the document scanner.

2. The method of claim 1 where the detecting includes the document scanner scanning the detached apparatus.

3. The method of claim 1 where the detached apparatus includes an apparatus recorded information and the detecting includes the document scanner scanning the apparatus recorded information.

4. The method of claim 1 where the detached apparatus is arranged to be disposed or received in an apparatus container and the detecting includes the document scanner scanning the apparatus container.

5. The method of claim 1 where the detached apparatus is arranged to be disposed or received in an apparatus container that includes an apparatus container recorded information and the detecting includes the document scanner scanning the apparatus container recorded information.

6. The method of claim 1 where the detecting includes the document scanner scanning an included detached apparatus media.

7. The method of claim 1 where the detecting includes the document scanner scanning an apparatus media recorded information that is comprised in an included detached apparatus media.

8. The method of claim 1 including providing one or more signals based on the detached apparatus, the one or more signals including at least a user signal that is based on when the detached apparatus can be attached to or used with the image forming device.

9-10. (canceled)

11. A method for an image forming device to identify a detached apparatus, the image forming device including a document scanner, the method comprising a detecting by an included sensor.

12. The method of claim 11 where the detecting includes the sensor sensing the detached apparatus.

13. The method of claim 11 where the detached apparatus includes an apparatus recorded information and the detecting includes the sensor sensing the apparatus recorded information.

14. The method of claim 11 where the detached apparatus is arranged to be disposed or received in an apparatus container and the detecting includes the sensor sensing the apparatus container.

15. The method of claim 11 where the detached apparatus is arranged to be disposed or received in an apparatus container that includes an apparatus container recorded information and the detecting includes the sensor sensing the apparatus container recorded information.

16. The method of claim 11 where the detecting includes the sensor sensing an included detached apparatus media.

17. The method of claim 11 where the detecting includes the sensor sensing an apparatus media recorded information that is comprised in an included detached apparatus media.

18-20. (canceled)

21. A method for an image forming device to identify a detached apparatus, the image forming device including a document scanner to scan a document, the method comprising a detecting by both the document scanner and also by an included sensor.

22-30. (canceled)

31. An image forming device arranged to identify a detached apparatus and to provide one or more signals based on the detached apparatus, the one or more signals including at least a user signal based on when the detached apparatus can be attached to or used with the image forming device, where the image forming device includes a document scanner and the identifying is based on a detecting by the document scanner.

32-33. (canceled)

34. The image forming device of claim 31 further including a sensor and where the identifying further is based on a detecting by the sensor.

35. The image forming device of claim 31, the a document scanner being arranged to scan a document based on a scanning signal that passes through an included scanning platen and the image forming device further including a sensor and where the identifying further is based on the sensor detecting signals that do not pass through the scanning platen.

36. The image forming device of claim 31 further including a sensor and where the identifying further is based on both the document scanner detecting signals that pass through an included scanning platen and further based on the sensor sensing signals that do not pass through the scanning platen.

37. The image forming device of claim 31 comprising a marking device that is devoid of a document scanner and that includes a sensor and arranged to identify the detached apparatus based on a detecting by the sensor.

38. (canceled)

39. The image forming device of claim 31, the detached apparatus comprising one or more media sheets and where the image forming device comprises a media supply means and is arranged to provide a user signal based on when the one or more media sheets can be disposed in the media supply means.

40. (canceled)

41. The image forming device of claim 31 where the detached apparatus includes an apparatus shape and the identifying is based on the apparatus shape.

42. The image forming device of claim 31 where the detached apparatus is arranged to be disposed or received in an apparatus container that includes an apparatus container shape and the identifying is based on the apparatus container shape.

43. The image forming device of claim 31 where the identifying is based on an apparatus media shape that is comprised in an included detached apparatus media.
